(19) United States
(12) Patent Application Publication
(10) Pub. No.: US 2013/0298444 A1
(43) Pub. Date: Nov. 14, 2013

(54) STINK BUG TRAP

(71) Applicant: Andrew Paul Strube, Columbia, PA (US)

(72) Inventor: Andrew Paul Strube, Columbia, PA (US)

(21) Appl. No.: 13/891,317

(22) Filed: May 10, 2013

Related U.S. Application Data
(60) Provisional application No. 61/645,888, filed on May 11, 2012.

(51) Int. Cl. A01M 1/14

(52) U.S. Cl. CPC A01M 1/145
USPC 43/113; 43/107; 43/114

(57) ABSTRACT

A stink bug trap can include a first housing, a container that supports the first housing and extends from the first housing along a first direction. The container can include a body and a channel extending at least partially through the body along the first direction. The channel can be separated into an entrance chamber and a trapping chamber. The stink bug trap can further include a first stink bug attractant configured to lure stink bugs into the entrance chamber and a second stink bug attractant configured to lure the stink bugs from the entrance chamber and into the trapping chamber. A barrier that separates the entrance chamber from the trapping chamber is configured to substantially prevent the stink bugs from moving from the trapping chamber back to the entrance chamber after the stink bugs have been lured into the trapping chamber.

### CROSS REFERENCE TO RELATED APPLICATIONS

This application claims priority to U.S. Provisional Application No. 61/645,888 filed May 11, 2012 the contents of which are hereby incorporated by reference in their entirety herein.

### BACKGROUND

Stink bugs, which belong to a super family of insects known as pentatomidea, can be pests in a home or other building that is located within an infested area. Stink bugs will enter such buildings through cracks around windows, doors, siding, utility pipes, and other openings into the buildings.

Exterior applications of insecticides have been used and may offer some minor relief from infestations where the task of completely sealing the exterior is difficult or impossible. Unfortunately, because insecticides are broken down by sunlight, the residual effect of the material will be greatly decreased and may not kill the insects much beyond several days or a week.

Additionally, some nontoxic methods have been used to control stink bugs. For example, stink bugs are attracted to the color yellow, and yellow sticky traps for trapping stink bugs have been used. Such traps will often times be impregnated with a pheromone to lure the stink bugs to the traps, and once they land on the sticky portion of the trap, the stink bugs will be trapped and then subsequently disposed of.

While various traps and insecticides have been used to control stink bug infestations in and around homes and other buildings, there remains a need for improved traps and methods for controlling the problem.

### SUMMARY

In accordance with an embodiment, a stink bug trap can include a first housing and a container that supports the first housing and extends from the first housing along a first direction. The container can include a body, a channel that extends at least partially through the body along the first direction, and at least one aperture that extends through the body along a direction that is transverse to the first direction. The stink bug trap can also include a barrier that separates the channel into an entrance chamber and a trapping chamber. The barrier can define a passageway that is configured to direct the stink bugs from the entrance chamber and into the trapping chamber. The at least one aperture can extend through the body and into the entrance chamber such that stink bugs enter the entrance chamber through the at least one aperture, and the trapping chamber is configured to contain the stink bugs after the stink bugs enter the trapping chamber from the entrance chamber. The stink bug trap further includes a light source coupled to the first housing such that the light source directs light into the channel of the container and through the at least one aperture of the container so as to attract the sink bugs into the entrance chamber.

### BRIEF DESCRIPTION OF THE DRAWINGS

The foregoing summary, as well as the following detailed description of exemplary embodiments, will be better understood when read in conjunction with the appended drawings, in which there is shown in the drawings example embodiments for the purposes of illustration. It should be understood, however, that the application is not limited to the precise arrangements and systems shown, in the drawings:

FIG. 1A is a perspective view of a stink bug trap constructed in accordance with an embodiment, the stink bug trap being configured to hang from a structure;

FIG. 1B is an exploded perspective view of the stink bug trap shown in FIG. 1A, the stink bug trap including a first housing, a second housing, a rigid container extending between the first and second housings and having a plurality of apertures, a fluorescent light source coupled to the first housing and configured to be disposed within the container, and a barrier that is disposed within the container so as to separate the container into first and second chambers;

FIG. 1C is a cross-sectional view of the stink bug trap shown in FIG. 1A with the light source removed for clarity;

FIG. 2 is a bottom plan view of the container shown in FIG. 1B;

FIG. 3 is a bottom plan view of the first housing shown in FIG. 1B;

FIG. 4 is a top plan view of the second housing shown in FIG. 1B;

FIG. 5A is a perspective view of the barrier shown in FIG. 1B, the barrier having an upper end and a lower end and defining a passageway that extends through the barrier from the upper end to the lower end;

FIG. 5B is a top plan view of the barrier shown in FIG. 5A;

FIG. 6 is a schematic view of the stink bug trap shown in FIG. 1A in operation;

FIG. 7A is a perspective view of a stink bug trap constructed in accordance with another embodiment, the stink bug trap having a base and being configured to be supported on a structure; and

FIG. 7B is an exploded perspective view of the stink bug trap shown in FIG. 5A, the stink bug trap including a first housing, a second housing, a rigid container extending between the first and second housings and having a plurality of apertures, a fluorescent light source coupled to the first housing and configured to be disposed within the container, a barrier that is disposed within the container so as to separate the container into first and second chambers, and a base extending from the first housing.

### DETAILED DESCRIPTION

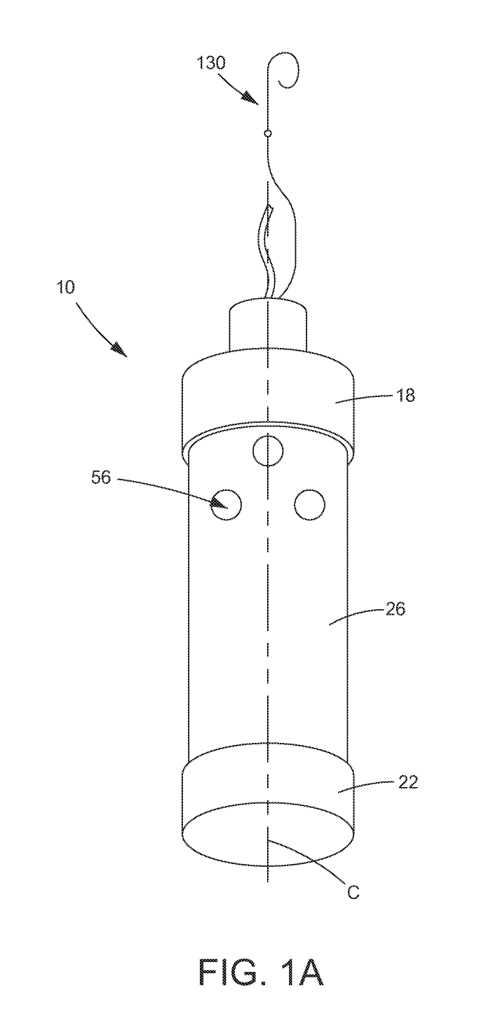

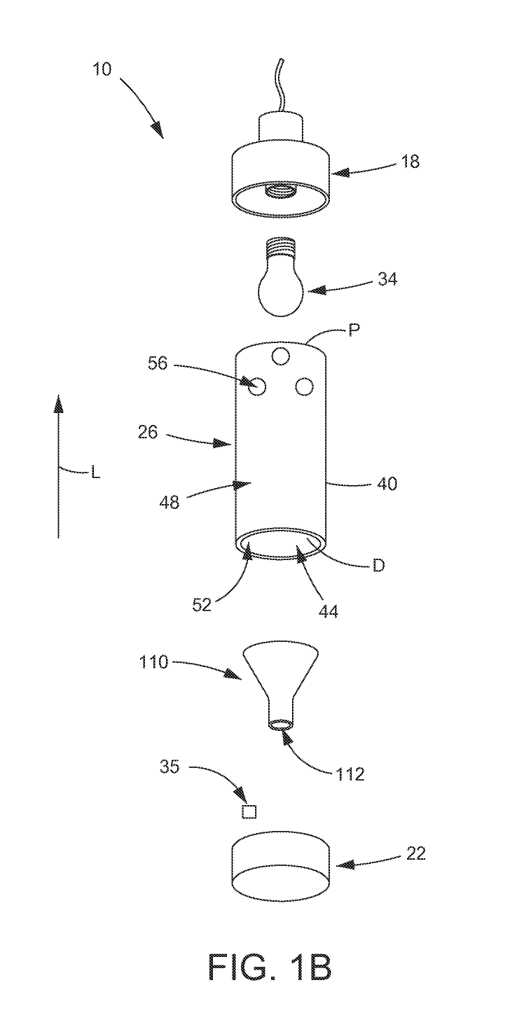

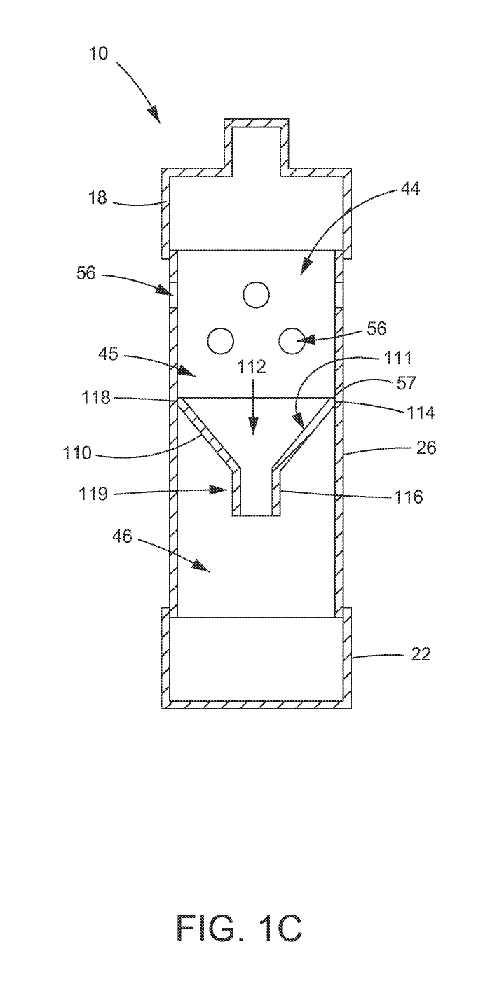

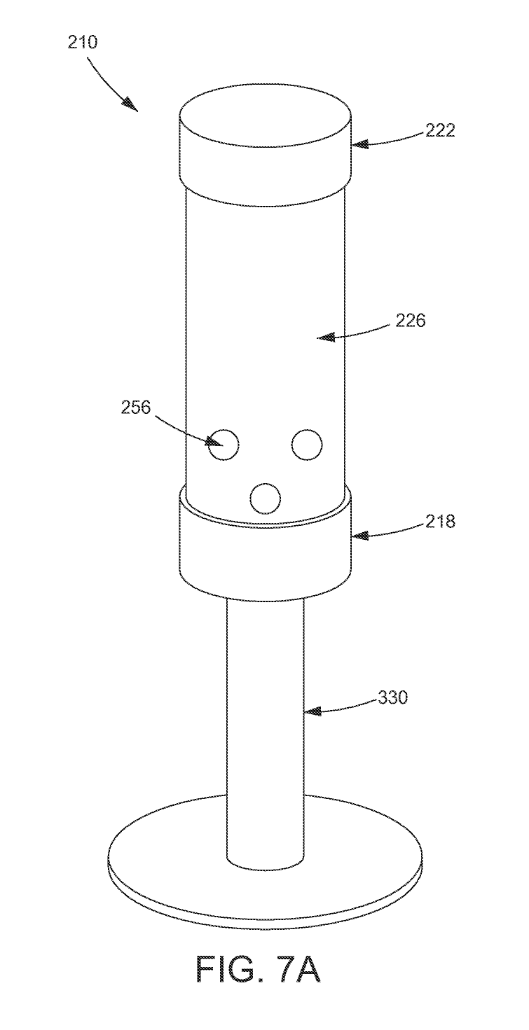

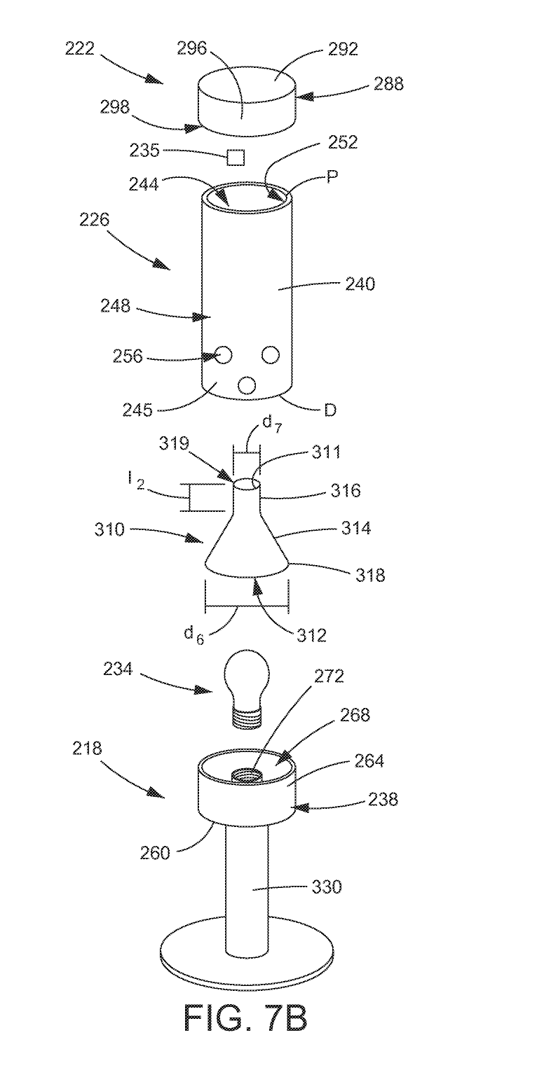

Referring to FIGS. 1A-1C, a stink bug trap 10 is configured to be positioned in an area that is infested with stink bugs such as inside a building or outside of a building to thereby eliminate the stinks bugs from the infested area. The stink bug trap 10 can thus be configured to attract and trap stink bugs from an ambient environment. The stink bug trap 10 can be configured as a hanging trap as shown in FIG. 1A or as a tabletop trap as shown in FIG. 7A. The stink bug trap 10 is configured to attract stink bugs to the trap 10 with a first stink bug attractant, and then subsequently lure the stink bugs into a trapping chamber of the trap 10 with a second stink bug attractant. It should be appreciated, however, that the stink bug trap 10 can be configured to lure or attract stink bugs with any number of stink bug attractants. For example, the stink bug trap 10 may be configured to attract stink bugs to the trap with the first stink bug attractant and the stink bugs can subsequently move into the trapping chamber without being enticed by a second stink bug attractant. When the stink bug trap 10 or at least the portion of the trap 10 that traps or otherwise retains the stink bugs is full, the stink bug trap 10 can be emptied and then reused.

The stink bug trap 10 can be configured to catch and retain stink bugs that are in all stages of a stink bugs life. That is, stink bugs go through 5-6 instars before becoming flying adults, and the stink bug trap 10 is not only configured to catch and retain flying adult stink bugs but also stink bugs that are in any one of the 5-6 instars. Stink bugs prior to becoming flying adults crawl to get to their desired destinations. Because they crawl, these stink bugs may avoid traps that use an adhesive as a primary trapping mechanism. The stink bug trap 10 utilizes a trapping chamber rather than an adhesive sleeve to catch and retain the stink bugs, and therefore can be configured to catch stink bugs that are in all stages of a stink bug's life.

As shown in FIGS. 1B and 1C, the stink bug trap 10 includes a first housing 18, a second housing 22, and a substantially rigid container 26 that extends between the first and second housings 18 and 22 along a first direction L and defines a central axis C. The first housing 18, the second housing 22, and the container 26 together define a structure that is configured to trap and retain stink bugs. The first housing 18, the second housing 22, and the container 26 can be separate components that are assembled together or they can be monolithic. The stink bug trap 10 can further include a first stink bug attractant, such as a light source 34, that is configured to attract or otherwise lure the stink bugs to the stink bug trap 10, and a second stink bug attractant 35, such as a scent, that is configured to attract or otherwise lure the stink bugs into a trapping portion of the stink bug trap 10. Therefore, the stink bug trap 10 can include one stink bug attractant that attracts the stink bugs to the trap itself and another stink bug attractant that lures the stink bugs into a specific portion of the trap that prevents the stink bugs from leaving the trap. It should be appreciated, however, that the first and second stink bug attractants 34 and 35 can be any attractants as desired. For example, while the first stink bug attractant 34 is illustrated as a light source, it should be appreciated, that the first stink bug attractant 34 can be a scent.

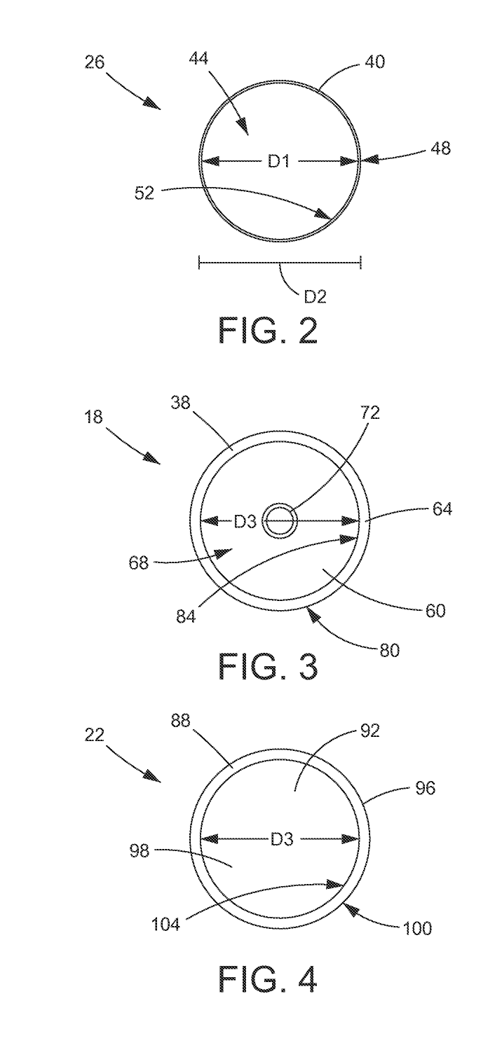

As shown in FIGS. 1B, 1C, and 2, the container 26 includes a body 40 that is elongate in the first direction L and defines a proximal end P and a distal end D. The container 26 further includes a cylindrical channel 44 that extends at least partially through the body 40 along the first direction L. In the illustrated embodiment, the channel 44 extends completely through the body 40, though it should be appreciated that the channel 44 can extend only partially through the body 40, as desired. Moreover, the channel 44 can have any shape as desired and is not limited to a cylindrical shape as illustrated. The container 26 can be made from any material as desired. For example, the container 26 can be made from a plastic material. Moreover, the container 26 can be at least translucent so as to allow light from the light source 34 to pass through the body 40. It should be appreciated however, that the container 26 can also be opaque so long as the body 40 includes some structure that allows light from the light source 34 to pass through the body 40.

As shown in FIG. 1C, the container 26, and in particular the channel 44 can be separated into a first or entrance chamber 45 and a second or trapping chamber 46. The entrance chamber 45 and the trapping chamber 46 can be separated from each other along the first direction such that the entrance chamber 45 is disposed above the trapping chamber 46 and is in communication with the light source 34. It should be appreciated, however, that in some embodiments, the entrance chamber 45 can be disposed below the trapping chamber 46. The stink bug trap 10 is configured such that the stink bugs enter into the entrance chamber 45 and then subsequently move into the trapping chamber 46 where they are trapped and retained until removal as desired.

The body 40 has an outer surface 48 and an inner surface 52. The container 26 includes at least one, such as a plurality of apertures 56 that extend through the body 40 from the outer surface 48 to the inner surface 52 so as to define openings into the entrance chamber 45 and place the at least one aperture 56 in fluid communication with the entrance chamber 45 and the ambient environment. The apertures 56 each extend through the body 40 along a second direction that is transverse to the first direction L. In the illustrated embodiment, the apertures 56 can each extend through the body 40 along a direction that is perpendicular to the first direction L, though it should be appreciated that the apertures 56 can each extend through the body 40 along a direction that is angularly offset with respect to the first direction L so long as they extend along a direction that is transverse to the first direction L. As shown, the apertures 56 each define a cylinder. It should be appreciated, however, that the apertures 56 can define any shape as desired so long as the apertures 56 extend through the body 40 so as to provide openings from outside of the container 26 through to the entrance chamber 45 of the channel 44. For example, the apertures can define rectangular shaped slots. The openings allow light from the light source 34 to pass through the body 40 so as to attract the stink bugs toward the container 26. The lured stink bugs then enter the entrance chamber 45 through the apertures 56.

As shown in FIGS. 1A and 1C, the apertures 56 can only provide openings into the entrance chamber 45 and not into the trapping chamber 46. Therefore, while stink bugs can be lured toward the trap 10 and can enter the entrance chamber 45 through the openings 56, they will be unable to escape the trapping chamber 46 after they have entered the trapping chamber 46.

As shown, the entrance chamber 45 can have a length measured along the first direction L. The container 26 can include apertures that extend into a portion of the entrance chamber that is less than 50% of the length of the entrance chamber 45, and preferably less than 25% of the length of the entrance chamber 45. By limiting the portion of the entrance chamber 45 that is in communication with the apertures 56, the trap 10 can maximize the rate of entry into the entrance chamber 45 while at the same time reducing the possibility of escape. In the illustrated embodiment, the container includes 2 rows of apertures 56 that extend into the entrance chamber 45 though it should be appreciated that the container 26 can include any number of rows of apertures 56 as desired.

As shown in FIG. 1C, the container 26 further includes an engagement member 57, such as a recess as illustrated. The engagement member 57 extends into the inner surface 52 of the body 40 and is disposed between the proximal and distal ends P and D. The engagement member 57 is configured to mate with a barrier to thereby couple the barrier to the container 26 so as to separate the channel 44 into the entrance chamber 45 and the trapping chamber 46. It should be appreciated, that the engagement member 57 can be located anywhere along the inner surface 52 of the body 40 and can have any configuration as desired. For example, the engagement member 57 can be a shelf or a slot that is configured to couple the barrier to the container 26.

As shown in FIGS. 1B and 2, the body 40 is cylindrical in shape, though it should be appreciated that the body 40 can include any shape as desired. The body 40 defines a first or inner dimension, such as a diameter D₁ that is measured with respect to the inner surface 52 of the body 40. The body 40 further defines a second or outer dimension, such as a diameter D₂ that is measured with respect to the outer surface 48 of the body 40. The diameter D₁ can be sufficient to allow a light bulb to extend into the channel 44 of the container 26.

Now in reference to FIGS. 1B and 3, the first housing 18 defines an upper cap 38 that is coupled to the proximal end P of the container 26. The first housing 18 can be removeably coupled or permanently coupled to the proximal end P of the container 26. The first housing 18 can include an outer wall 60 and a sidewall 64 that extends around the outer wall 60. The outer wall 60 and the sidewall 64 together define a cavity 68. The first housing 18 further includes a socket 72 that extends from the outer wall 60 and into the cavity 68. The socket 72 can be electrically coupled either directly or indirectly to an electrical source such as a battery, solar panel, power grid, or generator. The socket 72 is configured to receive the light source 34 such that the light source 34 extends at least partially into the channel 44 of the container 26. It should be appreciated, however, that the light source can be external to the channel 44 so long as light from the light source 34 is directed into the channel 44 and in particular into the entrance chamber 45 of the channel 44.

The sidewall 64 of the first housing 18 is cylindrical and defines an outer surface 80 and an inner surface 84. It should be appreciated, however, that the side wall 64 may define any shape as desired, so long as the first housing 18 can be coupled to the proximal end of the container 26. As shown in FIG. 3, the sidewall defines a first or inner dimension, such as diameter D₃ that is measured with respect to the inner surface 84 of the sidewall 64. As shown in FIG. 1B, the diameter D₃ is slightly greater than the outer diameter D₂ of the body 40 of the container 26 such that the first housing 18 can be coupled to the proximal end P of the container 26 through an interference fit. It should be appreciated, however, that the first housing 18 may further include a coupling member such as a thread that can engage a thread defined by the container 26 to thereby couple the first housing 18 to the container 26.

Similar to the first housing 18 and referring to FIG. 4, the second housing 22 defines a lower cap 88 that is coupled to the distal end D of the container 26. The second housing 22 is removeably coupled the distal end D of the container 26. The second housing 22 includes an outer wall 92 and a sidewall 96 that extends around the outer wall 92. The outer wall 92 and the sidewall 96 together define a cavity 98. The cavity 98 is configured to receive the distal end D of the container 26 to thereby releasably couple the second housing 22 to the container 26.

The sidewall 96 of the second housing 22 is cylindrical and defines an outer surface 100 and an inner surface 104. It should be appreciated, however, that the sidewall 96 may define any shape as desired, so long as the second housing 22 can be releasably coupled to the distal end of the container 26. As shown in FIG. 4, the sidewall 96 defines similar dimensions as the first housing 18. That is, the sidewall 96 of the second housing 22 also defines a first or inner dimension, such as diameter D₃ that is measured with respect to the inner surface 104 of the sidewall 96. As shown in FIG. 1B, the diameter D₃ is slightly greater than the second diameter D₂ of the body 40 of the container 26 such that the cavity 98 of the second housing 22 can receive the body 40 of the container 26 to thereby couple the second housing 22 to the distal end D of the container 26 through an interference fit. It should be appreciated, however, that the second housing 22 may further include a coupling member such as a thread that can engage a thread defined by the container 26 to thereby couple the second housing 22 to the container 26.

As shown in FIG. 1B, the first stink bug attractant can be a light source 34 and preferably is a fluorescent light source as illustrated. The fluorescent light source 34 can be mounted to the socket 72 of the first housing 18 such that the fluorescent light source 34 extends into the channel 44 of the container 26 or at least is capable of directing fluorescent light into the channel 44. The fluorescent light source 34 is configured to attract or otherwise lure stink bugs toward the entrance chamber 45. Certain flying insects, such as mosquitos are drawn toward ultraviolet (UV) light because they see UV light better than visible light, and because the flower patterns that attract flying insects are revealed in UV light. Unlike these flying insects, however, it has been found that stink bugs are not as attracted to UV light, but are instead more attracted to light sources that filter out UV light such as fluorescent light bulbs. Unlike other lights typically used in bug traps, fluorescent light bulbs filter out a high percentage of UV light leaving behind a high percentage of red, yellow, white, or even green lights. It has been found that stink bugs are more attracted to these lights rather than UV light as with typical flying insects. An example fluorescent light bulb that may be used is a 14 Watt, 23 Watt, or 32 Watt standard compact fluorescent light bulb manufactured by TCP, Incorporated having a place of business in Aurora, Ohio. Such light bulbs can have a light temperature of 2700 K. It should be appreciated, however, that the fluorescent light source is not limited to the disclosed example light bulbs. Moreover, it should be appreciated that while fluorescent light sources are preferred, other light sources may be used. For example, a light emitting diode or even a UV light can be used instead of a fluorescent light bulb to lure the stink bugs to the stink bug trap 10.

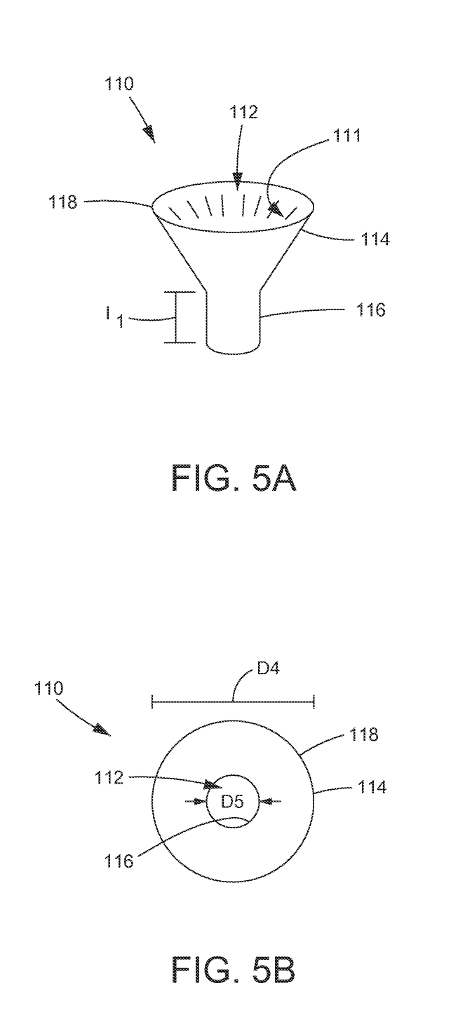

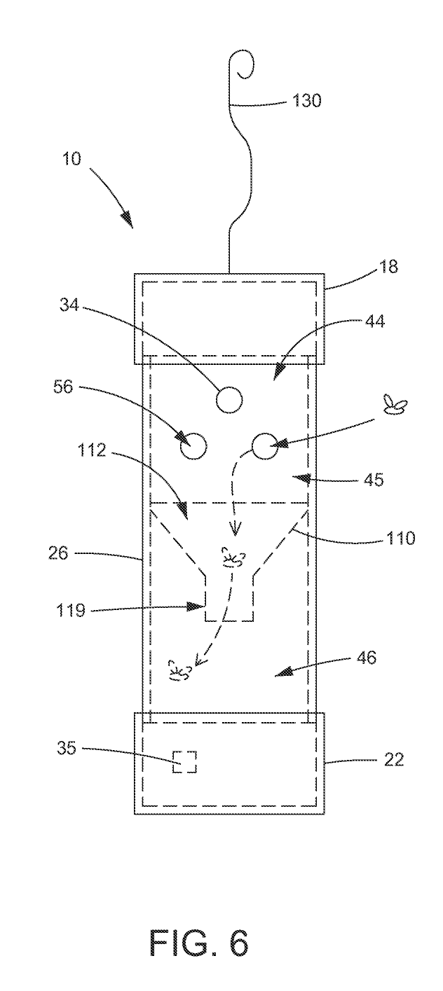

Now referring to FIGS. 1B, 1C, 5A, and 5B the container 26 can further include a barrier 110 that separates the entrance chamber 45 from the trapping chamber 46. The body 40 and the barrier 110 can be integrally formed as a monolithic structure or they can be separate components that are assembled together as desired. The barrier 110 can include an inner surface 111 that at least partially defines a passageway 112 that is configured to direct the stink bugs from the entrance chamber 45 and into the trapping chamber 46. As shown in FIG. 5A, the barrier 110 can be funnel shaped and can define a first or upper end 114 that is in communication with the entrance chamber 45 and a second or lower end 116 that is in communication with the trapping chamber 46. The passageway 112 and in particular the inner surface 111 can taper inwardly such that the passageway 112 has a first dimension d₄ measured along a direction that is transverse to the first direction at the upper end 114 and a second dimension d₅ measured along a direction that is transverse to the first direction at the lower end 116. As shown in FIG. 5B, the second dimension d₅ is substantially less than the first dimension d₄ so as to define the funnel shape. The first and second dimensions d₄ and d₅ can be diameters or any other dimensions as desired. The first dimension d₄ can be equal to or greater than the inner dimension D₁ of the container body 40 so as to create a barrier between the entrance and trapping chambers 45 and 46. Therefore, the only way into and out of the trapping chamber 46 is through the passageway 112, unless the second housing is removed. The second dimension d₅ can be between about 12 mm and about 24 mm, and is preferably about 18 mm. Though it should be appreciated that d₅ can be any dimension as desired.

The upper end 114 of the barrier 110 can include an engagement member 118 that is configured to engage the engagement member 57 of the container 26 to thereby couple the barrier 110 to the container 26. The engagement member 118 can be a lip or any other structure capable of engaging or otherwise mating with the engagement member 57. Once the barrier is coupled to the container 26, the only path into the trapping chamber 46 is through the passageway 112.

The lower end 116 of the barrier 110 can be cylindrically shaped as illustrated and can have a length l₁ measured along the longitudinal direction L. The length l₁ can be any length as desired and can have the dimension d₅ along the entire length l₁. It should be appreciated, however, that the lower end 116 can have any shape as desired and that the dimension d₅ can very along the length l₁. The lower end 116 can include or otherwise carry an inhibitor 119 such as an adhesive or a lubricant that inhibits or otherwise resists the stink bugs from moving back through the passageway 112 from the trapping chamber 46 to the entrance chamber 45. For example, the inhibitor can be a double sided adhesive tape. The adhesive or lubricant can be disposed on an outer surface of the barrier 110 external to the passageway 112. For example, the inhibitor 119 can be disposed at the very end of the lower end 116 on the outer surface of the barrier 110. Once the stink bugs enter the trapping chamber 46 through the passageway 112, the stink bugs will be substantially inhibited from exiting the trapping chamber 46 through the passageway 112 by the inhibitor.

The lower end of the trapping chamber 46 is selectively covered by the second housing 22. Therefore, the second housing 22 can partially define the trapping chamber 46. As shown in FIG. 1C, the stink bug trap 10 can include a second stink bug attractant 35 disposed within the trapping chamber 46. The second stink bug attractant can be a scent such as a pheromone or other scent as desired that is configured to lure the stink bugs from the entrance chamber 45 and into the trapping chamber 46. The second stink bug attractant 35 can be disposed within the second housing 22, or within the trapping chamber portion 46 of the channel 44. It should be appreciated, however, that the stink bug trap 10 can be void of the second stink bug attractant 35 and the stink bugs can move into the trapping chamber 46 from the entrance chamber 45 without being enticed.

Referring back to FIG. 1A, the stink bug trap 10 can also include a hanging mechanism 130 that extends proximally from the first housing 18. The hanging mechanism 130 can be a vinyl coated steel cable loop that is configured to attach to a pre-existing structure to thereby allow the stink bug trap 10 to hang from the structure. It should be appreciated, however, that the hanging mechanism 130 can have any configuration as desired so long as the stink bug trap 10 can hang from a structure. For example, the hanging mechanism 130 can also be a magnet or a suction cup.

In operation and in reference to FIG. 6, the stink bug trap 10 can be hung on a structure by the hanging mechanism 130 and the light source 34 can be turned on. Light from the light source 34 will be directed into the entrance chamber 45 of the channel 44 such that the light passes through the apertures 56 of the container 26. Therefore, the light that is produced by the light source 34 is visible to stink bugs that are external to the entrance chamber 45 and will attract or otherwise lure the stink bugs toward the entrance chamber 45. The stink bugs will then enter the entrance chamber 45 through the apertures 56. The bright light from the light source 34 will disorient the stink bugs and cause them to move away from light source 34, for example toward the passageway 112 of the barrier 110. Moreover, the second stink bug attractant 35 disposed within the trapping chamber 46 will further lure the stink bugs into the trapping chamber 46, for example by aromatically luring the stink bugs. Once the stink bugs enter the trapping chamber 46 they will be inhibited from exiting the trapping chamber 46 back through the passageway 112 by the inhibitor 119. Therefore, the stink bug trap 10 can trap stink bugs without a substantial amount of adhesive. That is, the stink bug trap 10 can trap stink bugs without using an adhesive as the primary trapping mechanism. As soon as the trapping chamber 46 is filled or has otherwise captured a plurality of stink bugs, the second housing 22 can be removed from the container 26 and the trapped stink bugs can be accesses so that at least some of the trapped stink bugs can be discarded or otherwise removed from the trapping chamber 46. The second housing 22 can then be recoupled to the container 26 and the process can be repeated as many times as desired.

Now referring to FIGS. 7A and 7B, the stink bug trap can be configured as a table top stink bug trap 210. The table top stink bug trap 210 is substantially similar to the stink bug trap 10 shown in FIG. 1A. Therefore, the stink bug trap 210 includes similar dimensioning and operates in a similar manner as the stink bug trap 10 shown in FIG. 1A unless otherwise stated. As shown in FIG. 7B, the stink bug trap 210 includes a first housing 218, a second housing 222, and a substantially rigid container 226 that extends between the first and second housings 218 and 222 along a first direction L. The first housing 218, the second housing 222, and the container 226 together define a container that is configured to trap and retain stink bugs. The stink bug trap 210 can further include a first stink bug attractant, such as a light source 234 that is configured to attract or otherwise lure the stink bugs to the stink bug trap 210, and a second stink bug attractant 235, such as a scent, that is configured to attract or otherwise lure the stink bugs into a trapping portion of the stink bug trap 210. Therefore, like the stink bug trap 10, the stink bug trap 210 can include one stink bug attractant that lures the stink bugs to the trap itself and another stink bug attractant that lures the stink bugs into a specific portion of the trap that prevents the stink bugs from leaving the trap.

The container 226 includes a body 240 that is elongate in the first direction L and defines a proximal end P and a distal end D. The container 226 further includes a cylindrical channel 244 that extends at least partially through the body 240 along the first direction L. In the illustrated embodiment, the channel 244 extends completely through the body 240, though it should be appreciated that the channel 244 can extend only partially through the body 240, as desired. Moreover, the channel 244 can have any shape as desired and is not limited to a cylindrical shape as illustrated. The container 226 can be made from any material as desired. For example, the container 226 can be made from a plastic material. Moreover, the container 226 can be at least translucent so as to allow light from the fluorescent light source 234 to pass through the body 240. It should be appreciated however, that the container 226 can also be opaque so long as the body 240 includes some structure that allows light from the light source 234 to pass through the body 240.

The container 226, and in particular the channel 244 can be separated into a first or entrance chamber 245 and a second or trapping chamber 246. The entrance chamber 245 and the trapping chamber 246 can be separated from each other along the first direction such that the entrance chamber 245 is disposed below the trapping chamber 246 and is in communication with the light source 234. It should be appreciated, however, that in some embodiments, the entrance chamber 245 can be disposed above the trapping chamber 246. The stink bug trap 210 is configured such that the stink bugs enter into the entrance chamber 245 and then subsequently move into the trapping chamber 246 where they are trapped and retained until removal as desired.

The body 240 has an outer surface 248 and an inner surface 252. The container 226 includes at least one, such as a plurality of apertures 256 that extend through the body 240 from the outer surface 248 to the inner surface 252 so as to define openings into the entrance chamber 245. The apertures 256 each extends through the body 240 along a direction that is transverse to the first direction L. In the illustrated embodiment, the apertures 256 each extend through the body 240 along a direction that is perpendicular to the first direction L, though it should be appreciated that the apertures 256 can each extend through the body 240 along a direction that is angularly offset with respect to the first direction L so long as they are extend along a direction that is transverse to the first direction L. As shown, the apertures 256 each define a cylinder. It should be appreciated, however, that the apertures 256 can define any shape as desired so long as the apertures 256 extend through the body 240 so as to provide openings from outside of the container 226 through to the entrance chamber 245 of the channel 244. For example, the apertures 256 can define rectangular shaped slots. The openings allow light from the light source 234 to pass through the body 240 so as to attract the stink bugs toward the container 226. The lured stink bugs then can enter the entrance chamber 245 through the apertures 256.

The first housing 218 defines a lower cap 238 that is coupled to the distal end D of the container 226. The first housing 218 can be removeably coupled or permanently coupled to the distal end D of the container 226. The first housing 218 includes an outer wall 260 and a sidewall 264 that extends around the outer wall 260. The outer wall 260 and the sidewall 264 together define a cavity 268. The first housing 218 further includes a socket 272 that extends from the outer wall 260 and into the cavity 268. The socket 272 can be electrically coupled to an electrical source such as a battery, solar panel, power grid, or generator. The socket 272 is configured to receive the light source 234 such that the light source 234 extends at least partially into the channel 244 of the container 226. It should be appreciated, however, that the light source can be external to the channel 244 so long as light from the light source 234 is directed into the channel 244 and in particular into the entrance chamber 245 of the channel 244.

Similar to the first housing 218, the second housing 222 defines an upper cap 288 that is coupled to the proximal end P of the container 226. The second housing 222 is removeably coupled the proximal end P of the container 226. The second housing 222 includes an outer wall 292 and a sidewall 296 that extends around the outer wall 292. The outer wall 292 and the sidewall 296 together define a cavity 298. The cavity 298 is configured to receive the proximal end P of the container 226 to thereby releasably couple the second housing 222 to the container 226.

As shown in FIG. 7B, the first stink bug attractant can be a light source 234 and preferably is a fluorescent light source 234, as illustrated. The fluorescent light source 234 can be mounted to the socket 272 of the first housing 218 such that the fluorescent light source 234 extends into the channel 244 of the container 226 or at least light from the fluorescent light source 234 is directed into the channel 244. The fluorescent light source 234 is configured to attract or otherwise lure stink bugs toward the entrance chamber 245. Certain flying insects, such as mosquitos are drawn toward ultraviolet (UV) light because they see UV light better than visible light, and because the flower patterns that attract flying insects are revealed in UV light. Unlike these flying insects, however, it has been found that stink bugs are not as attracted to UV light, but are instead more attracted to light sources that filter out UV light such as fluorescent light bulbs. Unlike other lights typically used in bug traps, fluorescent light bulbs filter out a high percentage of UV light leaving behind a high percentage of red, yellow, white, or even green lights. It has been found that stink bugs are more attracted to these lights rather than UV light as with typical flying insects. An example fluorescent light bulb that may be used is a 14 Watt, 23 Watt, or 32 Watt standard compact fluorescent light bulb manufactured by TCP, Incorporated having a place of business in Aurora, Ohio. Such light bulbs can have a light temperature of 2700 K. It should be appreciated, however, that the fluorescent light source is not limited to the disclosed example light bulbs. Moreover, it should be appreciated that while fluorescent light sources are preferred, other light sources may be used. For example, a light emitting diode can be used instead of a fluorescent light bulb to lure the stink bugs to the stink bug trap 210.

With continued reference to FIG. 7B, the stink bug trap 210 can further include a barrier 310 that separates the entrance chamber 245 from the trapping chamber 246. The barrier 310 can include an inner surface 311 that defines a passageway 312 that is configured to direct the stink bugs from the entrance chamber 245 and into the trapping chamber 246. As shown in FIG. 7B, the barrier 310 can be funnel shaped and can define a first or lower end 314 and a second or upper end 316. The passageway 312 and in particular the inner surface 311 can taper such that the passageway 312 has a first dimension d₆ measured along a direction that is transverse to the first direction at the lower end 314 and a second dimension d₇ measured along a direction that is transverse to the first direction at the upper end 316. As shown in FIG. 7B, the second dimension d₇ is substantially less than the first dimension d₆ so as to define the funnel shape. The first and second dimensions d₆ and d₇ can be diameters or any other dimensions as desired.

The lower end 314 of the barrier 310 can include an engagement member 318 that is configured to engage the engagement member 257 of the container 226 to thereby couple the barrier 310 to the container 226. The engagement member 318 can be a lip or any other structure capable of engaging or otherwise mating with the engagement member 257. Once the barrier is coupled to the container 226, the only path into the trapping chamber 246 is through the passageway 312.

The upper end 316 of the barrier 310 can be cylindrically shaped as illustrated and can have a length l₂ measured along the longitudinal direction L. The length l₂ can be any length as desired and can have the dimension d₇ along the entire length l₂. It should be appreciated, however, that the upper end 316 can have any shape as desired and that the dimension d₇ can very along the length l₂. The upper end 316 can include an inhibitor 319 such as an adhesive or a lubricant that inhibits the stink bugs from moving back through the passageway 312 from the trapping chamber 246 to the entrance chamber 245. In particular the adhesive or lubricant can be disposed on an outer surface of the barrier 310 external to the passageway 312. Once the stink bugs enter the trapping chamber 246 through the passageway 312, the stink bugs will be substantially inhibited from exiting the trapping chamber 246 through the passageway 312 by the adhesive or lubricant.

The upper end of the trapping chamber 246 is selectively covered by the second housing 222. Therefore, the second housing 222 can partially define the trapping chamber 246. The stink bug trap 210 can include a second stink bug attractant 235 disposed within the trapping chamber 246. The second stink bug attractant 235 can be a scent such as a pheromone or other scent as desired that is configured to lure the stink bugs from the entrance chamber 245 and into the trapping chamber 246. The second stink bug attractant 235 can be disposed within the second housing 222, or within the trapping chamber portion 246 of the channel 244. It should be appreciated, however, that the stink bug trap 210 can be void of the second stink bug attractant 235 and the stink bugs can move into the trapping chamber 246 from the entrance chamber 245 without being enticed.

Referring to FIG. 7A, the stink bug trap 210 can also include a base 330 that extends distally from the first housing 218. The base 330 can be a platform that is configured to rest on a pre-existing structure to thereby allow the stink bug trap 210 to sit or otherwise be supported by the structure. It should be appreciated, however, that the base 330 can have any configuration as desired so long as the stink bug trap 210 can be supported by a structure. For example, the base 330 can also be a pole that is inserted into the ground.

In operation, the stink bug trap 210 can be placed on a surface and supported by the base 330 and the light source 234 can be turned on. Light from the light source 234 will be directed into the entrance chamber 245 of the channel 244 such that the light passes through the apertures 256 of the container 226. Therefore, the light that is produced by the light source 234 is visible to stink bugs that are external to the entrance chamber 245 and will attract or otherwise lure the stink bugs toward the entrance chamber 245. The stink bugs will then enter the entrance chamber 245 through the apertures 256. The bright light from the light source 234 will disorient the stink bugs and cause them to move away from light source 234, for example toward the passageway 312 of the barrier 310. Moreover, the second stink bug attractant 235 disposed within the trapping chamber 246 will further lure the stink bugs into the trapping chamber 246. Once the stink bugs enter the trapping chamber 246 they will be inhibited from exiting the trapping chamber 246 back through the passageway 312 by the inhibitor 319. Therefore, the stink bug trap 210 can trap stink bugs without a substantial amount of adhesive. That is, the stink bug trap 210 can trap stink bugs without using an adhesive as the primary trapping mechanism. As soon as the trapping chamber 246 is filled or has otherwise captured a plurality of stink bugs, the second housing 222 can be removed from the container 226 and the trapped stink bugs can be discarded. The second housing 222 can then be recoupled to the container 226 and the process can be repeated as many times as desired.

The stink bug traps 10 and 210 can further include a solar panel system that is configured to power the light source 34 or 234 respectively. The solar panel system includes a solar panel, a battery cell(s) configured to store power produced by the solar panel, and a photoelectric dusk to dawn sensor for automatic on/off operation. The solar panel can vary in size, shape, voltage output and mounting position suitable to sustain many variable configurations. For example, the solar panel can be mounted onto the first housing 18 or the first housing 218 depending on the configuration of the stink bug trap. Moreover, the solar panel can be mounted on a structure that is independent to the stink bug trap, as desired.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description. For example, the barrier 110 and 310 can include configurations other than funnel shaped configurations. Moreover it should be appreciated that the term stink bug includes all forms of stink bugs such as the brown marmorated stink bug and the kudzu bug, for example. Furthermore, any features of one described embodiment can be applicable to the other embodiments described herein.

What is claimed:

1. A stink bug trap configured to attract and trap stink bugs from an ambient environment, the stink bug trap comprising:
a container including a body, a channel that extends at least partially through the body along a first direction, and a barrier that separates the channel into an entrance chamber and a trapping chamber, the barrier defining a passageway having a first end in communication with the entrance chamber and a second end in communication with the trapping chamber, the container further defining at least one aperture that extends at least into the body along a second direction that is transverse to the first direction so as to place the aperture in fluid communication with the entrance chamber and the ambient environment; and
a light source configured to direct light into the channel of the container and through the at least one aperture of the container so as to attract sink bugs through the at least one aperture and into the entrance chamber, wherein the passageway is configured to receive the attracted stink bugs from the entrance chamber and direct the attracted stink bugs into the trapping chamber so as to trap the attracted stink bugs.

2. The stink bug trap of claim 1, wherein the light source is a fluorescent light source.

3. The stink bug trap of claim 1, wherein the passageway has a first dimension measured along the second direction at the first end, and a second dimension measured along the second direction at the second end, the second dimension being less than the first dimension.

4. The stink bung trap of claim 3, wherein at least a portion of the passageway is tapered inwardly along a direction from the first end toward the second end.

5. The stink bug trap of claim 3, wherein the barrier is funnel shaped.

6. The stink bug trap of claim 3, wherein the second end of the barrier includes an inhibitor that resists the trapped stink bugs from traveling from the trapping chamber, through the barrier, and into the entrance chamber.

7. The stink bug trap of claim 6, wherein the inhibitor is an adhesive or a lubricant.

8. The stink bug trap of claim 5, wherein the inhibitor is carried at the second end of the barrier.

9. The stink bug trap of claim 8, wherein the barrier defines an inner surface that at least partially defines the passageway, and an opposed outer surface, and the inhibitor is disposed on the outer surface.

10. The stink bug trap of claim 1, wherein the second end is substantially cylindrically shaped.

11. The stink bug trap of claim 1, wherein the first end is an upper end, and the second end is a lower end when the stink bug trap is in use.

12. The stink bug trap of claim 1, wherein the container includes a plurality of apertures that extend through the body along the second direction and into the entrance chamber.

13. The stink bug trap of claim 1, further comprising a first housing that is supported by the container, wherein the light source is coupled to the first housing.

14. The stink bug trap of claim 13, further comprising a second housing, wherein the container extends between the first and second housings, and removal of the second housing allows the trapping chamber to be emptied.

15. The stink bug trap of claim 14, wherein at least one of the trapping chamber and the second housing includes a second stink bug attractant.

16. The stink bug trap of claim 15, wherein the second stink bug attractant is a scent.

17. A stink bug trap comprising:
a container including a body that is elongate along a first direction, the container defining a channel that extends at least partially through the body along the first direction, the container further including a barrier that separates the channel into an entrance chamber and a trapping chamber,
a first stink bug attractant disposed in the entrance chamber and configured to attract stink bugs into the entrance chamber; and
a second stink bug attractant different than the first stink bug attractant, the second stink bug attractant disposed in the trapping chamber and configured to lure the attracted stink bugs from the entrance chamber, through the barrier, and into the trapping chamber;
wherein the barrier is configured to substantially prevent the lured stink bugs from moving from the trapping chamber back to the entrance chamber.

18. The stink bug tap of claim 17, wherein the barrier defines a passageway having a first end in communication with the entrance chamber and a second end in communication with the trapping chamber.

19. The stink bug trap of claim 18, wherein the passageway has a first dimension measured along a direction that is transverse to the first direction at the first end and a second dimension measured along a direction that is transverse to the first direction at the second end, the second dimension being less than the first dimension.

20. The stink bug trap of claim 19, wherein at least a portion of the passageway is tapered inwardly along a direction from the first end toward the second end.

21. The stink bug trap of claim 18, wherein the barrier includes an inhibitor that resists the trapped stink bugs from traveling from the trapping chamber, through the barrier, and into the entrance chamber.

22. The stink bug trap of claim 21, wherein the inhibitor is an adhesive or a lubricant.

23. The stink bug trap of claim 21, wherein the inhibitor is carried at a lower end of the barrier.

24. The stink bug trap of claim 23, wherein the barrier defines an inner surface that at least partially defines the passageway, and an opposed outer surface, and the inhibitor is disposed on the outer surface.

25. The stink bug trap of claim 18, wherein the first end is an upper end and the second end is a lower end.

26. The stink bug trap of claim 17, wherein the container includes at least one aperture that extends through the body along a direction that is transverse to the first direction and into the entrance chamber such that the stink bugs enter the entrance chamber through the at least one aperture.

27. The stink bug trap of claim 26, wherein the first stink bug attractant is a light source that directs light into the channel of the container and through the at least one aperture so as to attract the sink bugs toward into the entrance chamber.

28. The stink bug trap of claim 17, further comprising a first housing and a second housing, wherein the container extends between the first and second housings and removal of the second housing allows the trapping chamber to be emptied.

29. A method of trapping stink bugs, the method comprising:
illuminating a light source so as to attract stink bugs into an entrance chamber of a container, the container including a barrier that separates the entrance chamber from a trapping chamber of the container;
aromatically luring the stink bugs from the entrance chamber through the barrier and into the trapping chamber;
trapping the aromatically lured stink bugs in the trapping chamber; and
accessing the trapping chamber after a plurality of stink bugs have been lured into the trapping chamber to thereby remove at least some of the trapped stink bugs from the trapping chamber.

30. The method of claim 29, wherein the step of illuminating the stink bugs comprises directing a fluorescent light source through at least a portion of the container.
